(19) United States
(12) Patent Application Publication
(10) Pub. No.: US 2024/0128540 A1
(43) Pub. Date: Apr. 18, 2024

(54) BATTERY UNIT

(71) Applicant: ISUZU MOTORS LIMITED, Tokyo (JP)

(72) Inventor: Hayato SAITO, Fujisawa-shi, Kanagawa (JP)

(21) Appl. No.: 18/547,127

(22) PCT Filed: Mar. 18, 2022
(86) PCT No.: PCT/JP2022/012775

§ 371 Date: Aug. 18, 2023

(30) Foreign Application Priority Data
Mar. 22, 2021 (JP) 2021-046933

(51) Int. Cl. H01M 10/6554; H01M 10/613; H01M 10/647; H01M 50/209

(52) U.S. Cl. CPC H01M 10/6554; H01M 10/613; H01M 10/647; H01M 50/209

(57) ABSTRACT

This battery unit includes: a plurality of battery cells arranged side by side in a prescribed direction; a cooling part that cools the plurality of battery cells by exchanging heat between the plurality of battery cells and a heat transfer medium; first members which are disposed between the plurality of battery cells and the cooling part and each of which has a plurality of first protrusions formed so as to make contact with every other cell of the plurality of battery cells in the prescribed direction; and second members which are disposed between the plurality of battery cells and the cooling part and each of which has a plurality of second protrusions formed so as to make contact with the cells, among the plurality of battery cells, which are not in contact with the first members in the prescribed direction.

The present application is a U.S. National Stage entry of PCT Application number PCT/JP2022/012775, filed on Mar. 18, 2022, which claims priority under 35 U.S.C § 119(a) to Japanese Patent Application No. 2021-046933, filed on Mar. 22, 2021, contents of which are incorporated herein by reference in their entirety.

### TECHNICAL FIELD

The present disclosure relates to a battery unit.

### BACKGROUND OF THE INVENTION

A vehicle is provided with a battery. Patent Document 1 discloses a structure in which a plurality of heat transfer plates arranged with heat dissipating sheets are respectively fixed to a plurality of battery cells.

### PRIOR ART

### Patent Document

Patent Document 1: Japanese Unexamined Patent Application Publication No. 2018-18629

### BRIEF DESCRIPTION OF THE INVENTION

### Problem to be Solved by the Invention

A thermally conductive material may be provided between a plurality of battery cells and a cooling part in order to uniformly cool the plurality of battery cells. In this case, if a battery cell experiences thermal runaway, heat is transferred from the battery cell that has experienced thermal runaway to an adjacent battery cell through the thermally conductive material by thermal conduction. This has led to a problem that the temperature of a battery cell adjacent to a battery cell experiencing thermal runaway increases, resulting in the adjacent battery being burnt out by transferred heat.

The present disclosure focuses on this point, and an object thereof is to provide a battery unit in which heat is barely transferred between adjacent battery cells.

### Means for Solving the Problem

A first aspect of the disclosure provides a battery unit that includes a plurality of battery cells arranged side by side in a predetermined direction, a cooling part that cools the plurality of battery cells by exchanging heat between the plurality of battery cells and a heat transfer medium, a first member that is provided between the plurality of battery cells and the cooling part and has a plurality of first convex portions which contact the plurality of battery cells, in a manner to contact every other battery cell, and a second member that is provided between the plurality of battery cells and the cooling part and has a plurality of second convex portions which contact the plurality of battery cells that are not in contact with the first member.

Further, the plurality of first members may be provided in the direction orthogonal to the predetermined direction, the plurality of second members may be provided in the direction orthogonal to the predetermined direction, and the first members and the second members may be provided in an alternating manner in the direction orthogonal to the predetermined direction.

Furthermore, the amount of heat transferred from a first battery cell in contact with the first member to a second battery cell in contact with the second member through the first member and the second member may be smaller than the amount of heat transferred from the first battery cell to a first battery cell, other than the first battery cell, in contact with the first member through the first member and the second member.

In addition, the plurality of first convex portions may contact the first battery cells, which are some of the plurality of battery cells, in a manner to contact every other battery cell. Further, the plurality of second convex portions may contact the second battery cells, which are different from the first battery cells, among the plurality of battery cells in a manner to contact every other battery cell.

### Effect of the Invention

According to the present disclosure, it is possible to make heat barely transferred between adjacent battery cells in a battery unit.

### BRIEF DESCRIPTION OF THE DRAWINGS

FIG. 1 shows a structure of a battery unit according to the embodiment.

FIG. 2 shows a structure of the battery unit shown in FIG. 1 seen from a direction of an arrow A.

FIG. 3 is a cross-sectional view at a line X-X in FIG. 2.

FIG. 4 is a cross-sectional view at a line Y-Y in FIG. 2.

FIG. 5 shows a structure of a conventional battery unit as a comparative example.

FIG. 6 shows an example of a battery cell in the conventional battery unit in a state of thermal runaway.

FIG. 7A shows an example of a battery cell in the battery unit according to the embodiment, in a state of thermal runaway.

FIG. 7B shows an example of a battery cell in the battery unit according to the embodiment, in a state of thermal runaway.

### DESCRIPTION OF EMBODIMENTS

### [Structure of Battery Unit S]

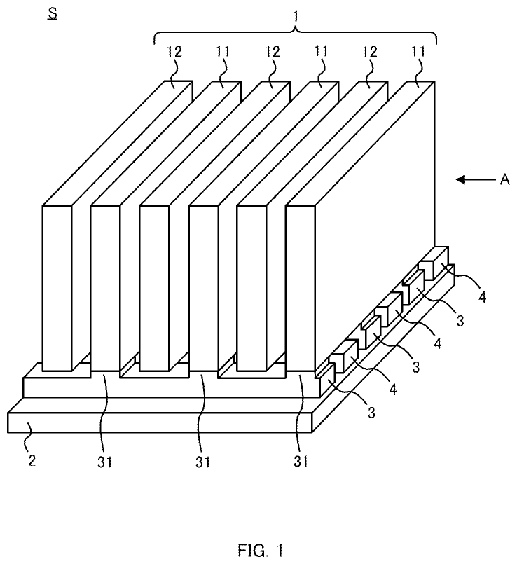

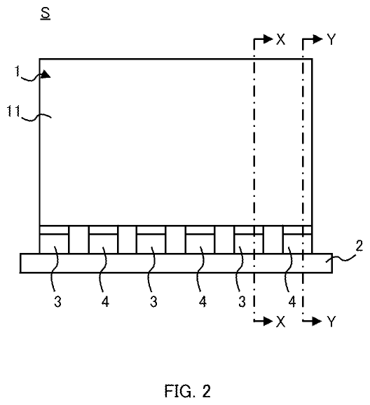

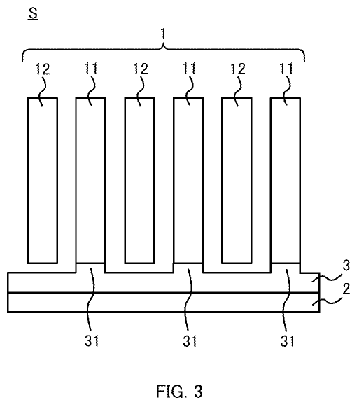

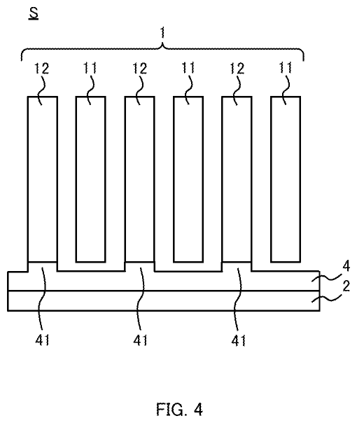

FIG. 1 shows a structure of a battery unit S according to the embodiment. FIG. 2 shows a structure of the battery unit S shown in FIG. 1 seen from a direction of an arrow A. FIG. 3 is a cross-sectional view at a line X-X in FIG. 2. FIG. 4 is a cross-sectional view at a line Y-Y in FIG. 2.

The battery unit S is used as a power supply battery for driving a traveling motor of a hybrid vehicle or an electric vehicle (EV). The battery unit S includes a plurality of battery cells 1, a cooling part 2, a first member 3, and a second member 4.

The battery cells 1 store electric power. Each battery cell 1 has a plate-shape, for example. The plurality of battery cells 1 are arranged side by side in a predetermined direction. A space is formed between the plurality of battery cells 1. The battery unit S includes a plurality of first battery cells 11 and a plurality of second battery cells 12, as the plurality of battery cells 1. The first battery cells 11 are battery cells in contact with the first member 3 described later. The second battery cells 12 are battery cells in contact with the second member 4 described later. The second battery cells 12 and the first battery cells 11 are adjacent to each other.

The cooling part 2 cools the plurality of battery cells 1 by exchanging heat between the plurality of battery cells 1 and a heat transfer medium. The heat transfer medium includes water, for example. The cooling part 2 has thermal conductivity. A flow channel (not shown in figures) is formed in the cooling part 2. The heat transfer medium flows in the flow channel. The first member 3 and the second member 4, described later, contact a surface of the cooling part 2 facing the plurality of battery cells 1. The cooling part 2 cools the plurality of battery cells 1 by exchanging heat with the heat transfer medium in the flow channel through the first member 3 and the second member 4.

The first member 3 is provided between the plurality of battery cells 1 and the cooling part 2. The first member 3 has thermal conductivity. The first member 3 extends in a predetermined direction. The first member 3 has a plurality of first convex portions 31. The first convex portion 31 protrudes toward the battery cells 1. A plurality of the first convex portions 31 contact the plurality of battery cells 1, in a manner to contact every other battery cell 1. The first member 3 contacts the first battery cells 11. A surface of the first member 3 that is opposite to its surface in contact with the plurality of battery cells 1 contacts the cooling part 2.

The second member 4 is provided between the plurality of battery cells 1 and the cooling part 2. The second member 4 has thermal conductivity. The second member 4 extends in the predetermined direction. The second member 4 has a plurality of second convex portions 41. The second convex portions 41 protrude toward the battery cells 1. The plurality of second convex portions 41 contact the plurality of battery cells 1 that are not in contact with the first member 3. The plurality of second convex portions 41 contact the plurality of battery cells 1, in a manner to contact every other battery cell 1. The second member 4 contacts the second battery cells 12. A surface of the second member 4 that is opposite to its surface in contact with the plurality of battery cells 1 contacts the cooling part 2. The second member 4 does not contact the first member 3.

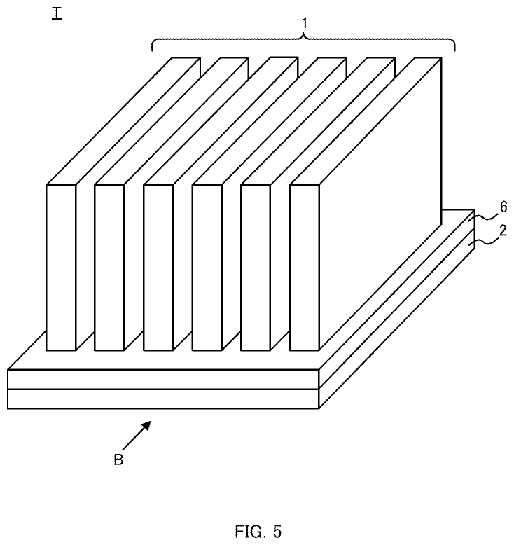

FIG. 5 shows a structure of a conventional battery unit T as a comparative example. The conventional battery unit T differs from the battery unit S in that the conventional battery unit T includes a third member 6 instead of the first member 3 and the second member 4.

The conventional battery unit T includes a plurality of battery cells 1, a cooling part 2, and the third member 6. The third member 6 is provided between the plurality of battery cells 1 and the cooling part 2. The third member 6 has thermal conductivity. The third member 6 has a flat plate shape. The third member 6 contacts all of the plurality of battery cells 1. A surface of the third member 6 that is opposite to its surface in contact with the plurality of battery cells 1 contacts the cooling part 2.

The battery unit T includes the third member 6 provided between the plurality of battery cells 1 and the cooling part 2 in this manner. Therefore, the plurality of battery cells 1 can be uniformly cooled regardless of the flow of the heat transfer medium in the flow channel of the cooling part 2, in the battery unit T. However, in the battery unit T, heat is easily transferred between adjacent battery cells 1 because heat is transferred to the adjacent battery cells 1 through the third member 6 by thermal conduction in addition to thermal transfer not through the third member 6.

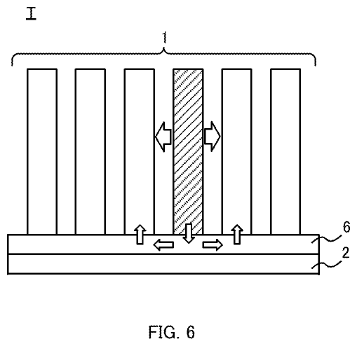

FIG. 6 shows an example of the battery cell 1 in the conventional battery unit T in a state of thermal runaway. It should be noted that FIG. 6 shows the structure of the battery unit T shown in FIG. 5 seen from the direction of an arrow B. The shaded battery cell 1 in FIG. 6 shows a battery cell 1 experiencing thermal runaway. Arrows in FIG. 6 indicate the flow of heat.

In the battery unit T, if the battery cell 1 experiences thermal runaway, heat is transferred from the battery cell 1 to an adjacent battery cell 1 through the third member 6 by thermal conduction. As a result, heat is transferred to the battery cells 1 adjacent to the battery cell 1 experiencing thermal runaway, from the battery cell 1 experiencing thermal runaway through the third member 6 in addition to thermal transfer not through the third member 6 (FIG. 6). Therefore, the battery cells 1 adjacent to the battery cell 1 experiencing thermal runaway are less safe, as the temperature of the battery cell 1 can easily increase, resulting in the adjacent batteries 1 being burnt out by transferred heat.

In contrast, the battery unit S of the embodiment includes the first member 3 and the second member 4 as described above. Therefore, it is easy to uniformly cool the plurality of battery cells 1 regardless of the flow of the heat transfer medium in the flow channel of the cooling part 2, in the battery unit S. Further, in the battery unit S, as the plurality of adjacent battery cells 1 do not contact one of the first member 3 and the second member 4, heat is barely transferred from the battery cell 1 to the adjacent battery cell 1 through the first member 3 and the second member 4 by thermal conduction. Therefore, heat is less likely to be transferred between the adjacent battery cells 1 in the battery unit S.

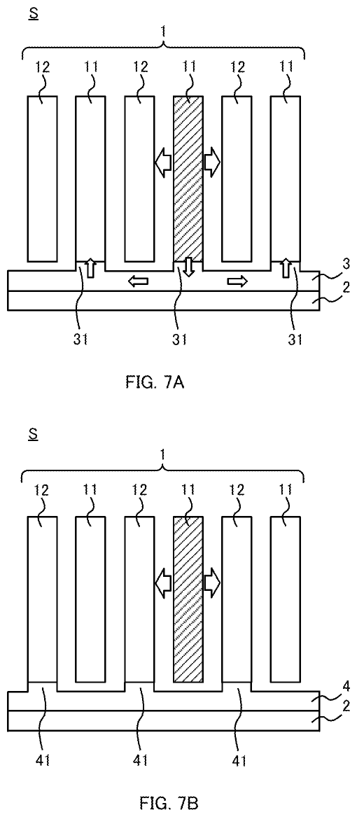

FIGS. 7A and 7B show an example of a battery cell in the battery unit S according to the embodiment, in a state of thermal runaway. Shaded battery cells 1 in FIGS. 7A and 7B show the battery cells 1 experiencing thermal runaway. Arrows in FIGS. 7A and 7B indicate the flow of heat. FIG. 7A is a cross-sectional view at the line X-X in FIG. 2. FIG. 7B is a cross-sectional view at the line Y-Y in FIG. 2.

In the battery unit S, if a battery cell 1 experiences thermal runaway, heat is barely transferred from the battery cell 1 to the adjacent battery cells 1 via the first member 3 and the second member 4 by thermal conduction (FIGS. 7A and 7B). Therefore, in the battery unit S, heat is less likely to be transferred from the battery cell 1 experiencing thermal runaway to the battery cells 1 adjacent to the battery cell 1 experiencing thermal runaway. As a result, in the battery unit S, the temperature of the battery cells 1 adjacent to the battery cell 1 experiencing thermal runaway is less likely to increase and so these battery cells 1 are less likely to burn out due to transferred heat, thus improving safety. In addition, in the battery unit S, the spacing between the plurality of battery cells 1 can be reduced.

In the battery unit S, the plurality of first members 3 are placed in a direction orthogonal to the predetermined direction. Further, in the battery unit S, the plurality of second members 4 are placed in the direction orthogonal to the predetermined direction. Also, the first members 3 and the second members 4 are provided in an alternating manner in the direction orthogonal to the predetermined direction. In the battery unit S, the first members 3 and the second members 4 are provided in this manner to facilitate uniform cooling of the plurality of battery cells 1.

In the battery unit S, the amount of heat transferred from the first battery cells 11 to the second battery cells 12 through the first members 3 and the second members 4 is smaller than the amount of heat transferred from a first battery cell 11 to a first battery cell 11 other than this first battery cell 11 through the first member 3 and the second member 4. Therefore, in the battery unit S, when heat is transferred through the first member 3 and the second member 4, it is harder for heat to be transferred between the first battery cells 11 and the second battery cells 12 than between the plurality of first battery cells 11.

### [Effects of Battery Unit S According to the Embodiment]

The battery unit S according to the embodiment includes the plurality of battery cells 1 arranged side by side in the predetermined direction, and the cooling part 2 that cools the plurality of battery cells 1 by exchanging heat between the plurality of battery cells 1 and the heat transfer medium. Further, the battery unit S includes the first member 3, which is provided between the plurality of battery cells 1 and the cooling part 2, has the plurality of first convex portions 31 that contact the plurality of battery cells 1 in a manner to contact every other first battery cell 1, and has thermal conductivity. In addition, the battery unit S includes the second member 4, which is provided between the plurality of battery cells 1 and the cooling part 2, has the plurality of second convex portions 41 that contact the plurality of battery cells 1 that are not in contact with the first member 3, and has thermal conductivity.

The battery unit S according to the embodiment includes the first member 3 and the second member 4 in this manner. Therefore, in the battery unit S, since the adjacent battery cells 1 do not contact one of the first member 3 and the second member 4, heat is barely transferred from battery cells 1 to adjacent battery cells 1 via the first member 3 and the second member 4 by thermal conduction. As a result, heat is less likely to be transferred between adjacent battery cells 1 in the battery unit S.

Therefore, in the battery unit S, if a battery cell 1 experiences thermal runaway, the temperature of the battery cells 1 adjacent to the battery cell 1 experiencing thermal runaway is less likely to increase and these battery cells 1 are less likely to burn out due to the transferred heat, thus improving safety. Further, in the battery unit S, the spacing between the plurality of battery cells 1 can be reduced.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

### DESCRIPTION OF SYMBOLS

S battery unit
1 battery cell
11 first battery cell
12 second battery cell
2 cooling part
3 first member
31 first convex portion
4 second member
41 second convex portion
T conventional battery unit
6 third member

1. A battery unit comprising:
a plurality of battery cells arranged side by side in a predetermined direction;
a cooling part that cools the plurality of battery cells by exchanging heat between the plurality of battery cells and a heat transfer medium;
a first member that is provided between the plurality of battery cells and the cooling part and has a plurality of first convex portions which contact the plurality of battery cells, in a manner to contact every other battery cell; and
a second member that is provided between the plurality of battery cells and the cooling part and has a plurality of second convex portions which contact the plurality of battery cells that are not in contact with the first member.

2. The battery unit according to claim 1, wherein
the plurality of first members are provided in the direction orthogonal to the predetermined direction,
the plurality of second members are provided in the direction orthogonal to the predetermined direction, and
the first members and the second members are provided in an alternating manner in the direction orthogonal to the predetermined direction.

3. The battery unit according to claim 1, wherein
the amount of heat transferred from a first battery cell in contact with the first member to a second battery cell in contact with the second member through the first member and the second member is smaller than the amount of heat transferred from the first battery cell to a first battery cell, other than the first battery cell, in contact with the first member through the first member and the second member.

4. The battery unit according to claim 1, wherein
the plurality of first convex portions contact the first battery cells, which are some of the plurality of battery cells, in a manner to contact every other battery cell.

5. The battery unit according to claim 4, wherein
the plurality of second convex portions contact the second battery cells, which are different from the first battery cells, among the plurality of battery cells in a manner to contact every other battery cell.

6. The battery unit according to claim 1, wherein
the first member and the second member are provided below the plurality of battery cells, and the first convex portions and the second convex portions are respectively provided on upper surfaces of the first member and the second member to support lower portions of the plurality of battery cells.

7. The battery unit according to claim 6, wherein
the cooling part is provided below the first member and the second member.
